(19) United States
(12) Patent Application Publication
(10) Pub. No.: US 2011/0256432 A1
(43) Pub. Date: Oct. 20, 2011

(54) BATTERY HUMIDITY CONTROL

(75) Inventors: Broc William TenHouten, Los Angeles, CA (US); Alex Hamade, Santa Monica, CA (US); Philippe Hart Gow, Santa Monica, CA (US)

(73) Assignee: Coda Automotive, Inc., Santa Monica, CA (US)

(21) Appl. No.: 13/084,725

(22) Filed: Apr. 12, 2011

Related U.S. Application Data
(60) Provisional application No. 61/325,033, filed on Apr. 16, 2010.

(51) Int. Cl. H01M 10/42; H01M 10/50; H01M 2/32; F24F 3/14

(52) U.S. Cl. 429/50; 165/230; 429/71; 429/61

(57) ABSTRACT

Systems and methods are provided for controlling humidity in gases exposed to batteries, which can be applied to humidity control in climate control gases in battery packs, for example those used in electric vehicles.

### RELATED APPLICATIONS

This application claims priority under 35 U.S.C. §119(e) to U.S. Provisional Patent Application No. 61/325,033, filed Apr. 16, 2010, and entitled “Battery Humidity Control,” which is incorporated herein by reference in its entirety for all purposes.

### FIELD OF INVENTION

Systems and methods related to controlling humidity in applications that employ a battery pack are generally described.

### BACKGROUND

Batteries can be used to provide power to a wide variety of devices, from portable consumer electronics to electric motor vehicles. In many cases, batteries can exhibit reduced performance when they are exposed to excess moisture. For example, excess moisture may lead to electrical current leakage within the battery. In addition, excess moisture can lead to corrosion. For these reasons, among others, the ability to control the humidity in battery compartments is desirable.

### SUMMARY OF THE INVENTION

The embodiments described herein generally relate to systems and methods for controlling humidity in applications that employ a battery pack. The subject matter of the present invention involves, in some cases, interrelated products, alternative solutions to a particular problem, and/or a plurality of different uses of one or more systems and/or articles.

In one aspect a system for inhibiting condensation within a battery pack and/or for controlling and/or altering humidity within a battery pack is provided. In one set of embodiments, the system can comprise a humidity sensor constructed and arranged to determine the humidity of a first gas portion to which at least one region within the battery pack is or will be exposed; and a control system constructed and arranged to alter, responsive at least in part to the humidity determination, a dew point of a second gas portion such that condensation is inhibited.

In some instances, the system can comprise a humidity sensor constructed and arranged to determine the humidity of a first gas portion to which at least one region within the battery pack is or will be exposed; and a control system constructed and arranged to alter, responsive at least in part to the humidity determination, at least one of a temperature of a second gas portion, a flow rate of a second gas portion, and/or a ratio of fresh to battery-pack recirculated components of a second gas portion.

The system can comprise, in some instances, a battery pack comprising at least one electrochemically rechargeable battery cell; a passageway fluidically connecting the battery pack to a gas outside the battery pack; a passageway within the battery pack constructed and arranged to provide a flow path for recirculated gas within the battery pack; a humidity sensor constructed and arranged to determine the humidity of at least one region within the battery pack and/or within the passageway; and a control system constructed and arranged to establish a ratio of a flow rate of the gas from outside the battery back to a flow rate of the recirculated gas based at least in part upon the humidity determination.

In some embodiments, the system can comprise a battery pack comprising at least one electrochemically rechargeable battery cell; a passageway fluidically connecting the battery pack to a gas outside the battery pack; a humidity sensor constructed and arranged to determine the humidity of at least one region within the battery pack and/or the passageway; and a control system constructed and arranged to alter a temperature of the gas from outside the battery pack based at least in part upon the humidity determination.

The system can comprise, in some cases, a battery pack comprising at least one electrochemically rechargeable battery cell; a passageway fluidically connecting the battery pack to a gas outside the battery pack; a humidity sensor constructed and arranged to determine the humidity of at least one region within the battery pack; and a control system constructed and arranged to alter a flow rate of the gas from outside the battery pack into the battery pack based at least in part upon the humidity determination.

In another aspect, a method for inhibiting condensation and/or controlling humidity within a battery pack is provided. In some embodiments, the method can comprise determining the humidity of a first gas portion to which at least one region within a battery pack is exposed, and altering a property of a second gas portion, based at least in part upon the humidity determination, such that the dew point of the second gas portion is lower than a minimum temperature within the at least one region within the battery pack.

The method can comprise, in some embodiments, determining the humidity of at least one region within a battery pack comprising at least one electrochemically rechargeable battery cell and/or within a passageway fluidically connecting the battery pack to a gas outside the battery pack, and altering at least one of a temperature of a gas transported into the battery pack, a flow rate of the gas transported into the battery pack, and/or a ratio of a flow rate of the gas transported into the battery pack to a flow rate of a gas recirculated within the battery pack based at least in part upon the humidity determination.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B include schematic illustrations of a battery system, according to one set of embodiments.

### DETAILED DESCRIPTION

Systems and methods are provided for controlling humidity in gases exposed to batteries, which can be applied to humidity control in climate control gases in battery packs, for example those used in electric vehicles. The humidity control systems and methods can be used to alter one or more properties of a system that is used to control the temperature of a battery pack, e.g. via a climate control gas. As noted, a humidity sensor can be used to determine the humidity of a gas, such as a battery pack climate control gas, to which at least one region within a battery pack is exposed. A control system can be used to alter a property of the gas in response to, at least in part, the humidity determination. In some cases, the control system can alter the temperature of the gas. As one example of a specific arrangement according to one embodiment of the invention, the humidity of a battery climate control gas can be determined, and the control system can then alter the temperature of the gas, responsive to the humidity determination, such that the dew point of the gas is reduced to or maintained at a temperature low enough to inhibit condensation in the battery pack. The control system can, in some embodiments, alter the flow rate of the gas (with or without simultaneously altering gas temperature).

In some cases, the gas can be part of a recirculation system, the use of which can reduce or eliminate the need to dehumidify fresh gas entering the system. The control system can, in some embodiments, alter the ratio of fresh gas to battery-pack recirculated components of the gas such that the dew point of the combined gas flow is reduced to or maintained at a temperature below the coldest part of the battery pack to which the gas is exposed.

Simultaneous humidity and temperature control in battery packs can be challenging. In many systems that do not employ humidity control, gas that is transported into a battery pack to control the pack temperature can include a relatively large amount of water vapor, which can condense on relatively cold portions of the battery pack. Condensation within a battery pack can lead to corrosion and current leakage, among other undesirable effects. These problems can be magnified by the fact that many systems employ battery packs with relatively large heat capacities, which are resistant to fast changes in temperature. In addition, it is often undesirable to heat batteries to avoid condensation, as overheating battery pack cells can lead to decreases in system performance. The inventors have discovered, within the context of the invention, that controllably modifying one or more properties of a gas to which the batteries are exposed can be effective in inhibiting or essentially eliminating condensation on or within the battery pack without the need for rapid changes in battery cell temperature. In addition, the inventors have discovered that modifying one or more properties of the climate control gas can allow for effective humidity control over a wide range of temperatures and ambient relative humidity conditions.

The embodiments described herein can be used to control the humidity of battery packs in a wide variety of applications. In some cases, the systems and methods described herein can be used to control the temperature of a battery pack used to power the drive train of an electric motor vehicle.

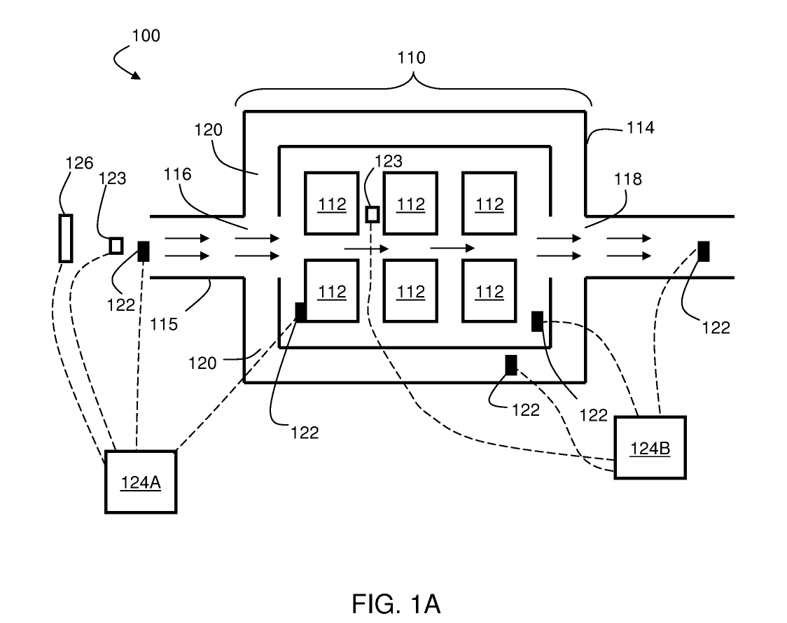

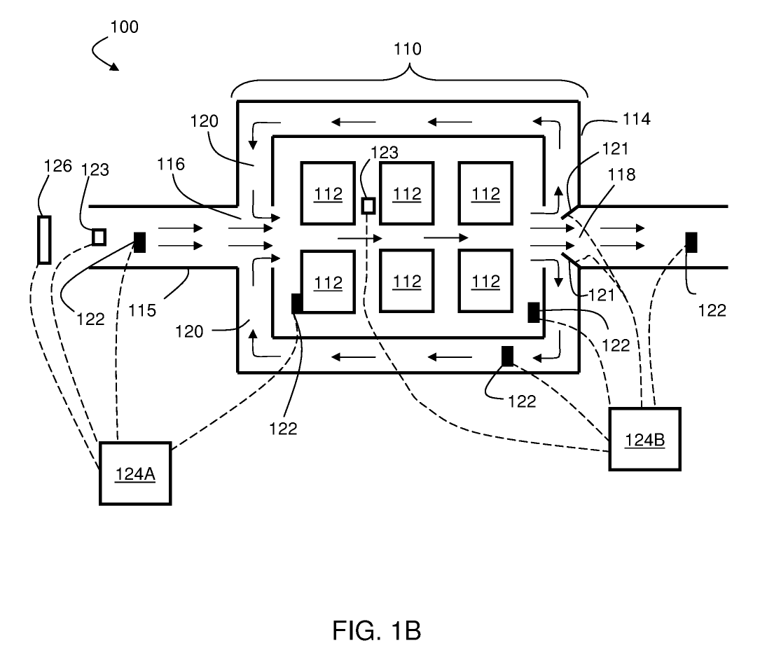

FIGS. 1A-1B include exemplary schematic diagrams illustrating humidity control in an exemplary battery pack system 100. In FIGS. 1A-1B, battery pack 110 includes a plurality of electrochemically rechargeable battery cells 112 arranged within a container 114. It should be understood that a “battery pack,” as used herein, can include a plurality of battery cells or a single battery cell.

In some embodiments, a passageway can fluidically connect the battery pack to a gas outside the battery pack. The term “fluidically connected,” as used herein, refers to two volumes constructed and arranged such that a fluid can flow between them. In some cases, the first and second volumes can be directly fluidically connected. As used herein, two devices are “directly fluidically connected” when the fluidic connection between the two articles is uninterrupted by the presence of additional devices.

The gas outside the battery pack can be used to control the climate (e.g., temperature, humidity, pressure, etc.) within the battery pack. For example, the gas outside the battery pack may be at a substantially different temperature than a region within the battery pack, and can therefore be used to heat or cool that region of the battery pack. In some cases, the gas outside the battery pack may have a relatively low humidity, and can therefore be used to transport moisture out of the battery pack.

The passageway that connects the battery pack to an outside gas can comprise, in some cases, a conduit through which gas can be transported. For example, in FIGS. 1A-1B, system 100 includes passageway 115 connected to the battery pack via inlet 116. In some cases, the passageway can include an inlet, but a separate conduit attached to the inlet may not be present. The battery pack may also include one or more outlets (e.g., outlet 118 in FIGS. 1A-1B) through which gas can be expelled from the battery pack. When one or more inlet(s) and outlet(s) of the battery pack are opened, as illustrated in FIG. 1A, gas from outside the battery pack can be transported through the battery pack to control the humidity within at least a region of the battery pack. Any suitable device can be used to establish the pressure drop required to transport the gas from outside the battery pack into the battery pack (e.g., a pump, fan, etc.).

The inlet(s) and outlet(s) and/or the passageway(s) that fluidically connect the battery pack to the outside gas can be arranged in any suitable manner. In some embodiments, the inlet(s) and outlet(s) are arranged to achieve a desired flow profile of gas within the container. For example, in FIG. 1A, inlet 116 and outlet 118 are arranged such that the gas is transported along multiple battery cells as it is transported from the inlet to the outlet, as indicated by the arrows in the figure. One of ordinary skill in the art would be capable of arranging the inlet(s) and outlet(s) to achieve a desired flow distribution within the battery packs described herein.

The gas from outside the battery pack can originate from any suitable source. For example, in some embodiments, the gas may comprise air transported directly to the battery pack from outside the device powered by the battery pack (e.g., an automobile, a portable electronics device, etc.) via an air intake system. In some cases, the gas may be transported to the battery pack from another source within the device powered by the battery pack (e.g., from a climate control system within a car, from a compressed air cylinder, etc.).

In some embodiments, gas can be recirculated within the battery pack. Recirculation of gas within the battery pack can be beneficial because it can obviate the need to dehumidify and/or alter the temperature of air from outside the battery pack. This can lead to significant energy savings and can reduce the amount of airflow-sourced condensate that needs to be removed from the system. In some embodiments, the battery pack can include a passageway constructed and arranged to provide a flow path for recirculated temperature climate control gas within the battery pack.

The passageway can comprise, in some embodiments, one or more channels through which recirculated gas can be transported. A “channel,” as used herein, refers to a feature on or in an article or substrate, or between two articles, that at least partially directs the flow of a fluid. A channel can have any cross-sectional shape (circular, semi-circular, oval, semi-oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and outlet(s). A channel may also have an aspect ratio (length to average cross sectional dimension) of at least 2:1, more typically at least 3:1, 5:1, or 10:1 or more.

FIGS. 1A-1B include optional channels 120 through which gas can be recirculated. In some cases, the passageway may not include any discrete internal channels, and may comprise a self-sustaining flow path within the battery pack. For example, the passageway may comprise a laminar flow stream of gas within the battery pack. One of ordinary skill in the art would be able to distinguish the difference between a self-sustaining flow path and incidental recirculation (e.g., via the formation of eddies) that may occur within a small portion of the battery pack. Any suitable device can be used to establish the pressure drop required to transport the recirculated fluid (e.g., a pump, fan, etc.).

In some instances, gas can be recirculated within the battery pack while fresh gas is supplied from outside the battery pack. For example, in the set of embodiments illustrated in FIG. 1B, gas is recirculated through channels 120 while gas from outside the battery pack is transported through inlet 116. In some instances, substantially no fresh gas may be transported through the battery pack while gas is recirculated within the pack. This can be achieved, for example, by closing inlet 116 and outlet 118 such that the battery pack is substantially sealed, thus prohibiting the flow of outside gas into the battery pack.

In some embodiments, a humidity sensor can be used to determine the humidity of a gas (e.g., a first portion of a gas) to which at least one region of the battery pack has been, is, or will be exposed. In some cases, a property of a gas (e.g., a second portion of a gas) to which at least one region of the battery pack has been, is, or will be exposed can be altered, responsive at least in part to the humidity determination. In some embodiments, the first and second gas portions can each be different portions of a larger volume of gas. In some such cases, the first and second gas portions can have substantially similar compositions. For example, the first and second gas portions can both comprise ambient air (e.g., both portions can be part of an ambient air stream, for example, used to control the climate of the battery pack). In some cases, the first and second gas portions can include substantially the same portions of gas. For example, the humidity of a portion of gas can be determined at an upstream location, and, once the gas has been transported to a downstream location, a property of that portion of gas can be altered. As another example, the humidity of a portion of gas can be determined at a location and, substantially simultaneously, a property of that portion of gas can be altered.

The embodiments illustrated in FIGS. 1A-1B include a plurality of humidity sensors 122 located in various parts of the system. A humidity sensor can be located within any suitable region. In some cases, a humidity sensor can be located within the battery pack. For example, the humidity sensor can be located on the surface of a cell within the pack or on a surface of the battery pack container (e.g., between cells within the pack). A humidity sensor can be located, in some cases, within a recirculation pathway within a battery pack. In some cases, a humidity sensor can be located within the inlet passageway that connects the battery pack to the gas outside the battery pack. A humidity sensor can be located, in some cases, in an outlet passageway downstream of the battery pack. One of ordinary skill in the art would be capable of positioning a humidity sensor in an appropriate location to achieve a desired humidity determination.

The humidity sensor can be of any suitable type. For example, in some embodiments, the humidity sensor may comprise a relative humidity sensor. In some cases, the humidity sensor can comprise a dew point sensor. Humidity sensors described herein can operate using any suitable functionality. In some embodiments, a humidity sensor can comprise a capacitive sensor. For example, a dielectric material can be exposed to a gas, and the humidity of the gas can be determined by measuring the change in the dielectric constant of the dielectric material (e.g., via measuring the change in capacitance between two electrodes positioned on either side of the dielectric material). In some cases, a humidity sensor can comprise a resistive humidity sensor. For example, the sensor can comprise a hygroscopic medium (e.g., a conductive polymer, salt, treated substrate, etc.). Upon exposing the hygroscopic medium to the gas, the humidity of the gas can be measured by determining the change in the electrical impedance of the hygroscopic medium (e.g., by measuring the change in current between two electrodes at a fixed electrical potential). In some embodiments, a humidity sensor can comprise a thermal conductivity humidity sensor. Such sensors can determine the humidity of a gas by measuring a change in the thermal conductivity of the gas. One of ordinary skill in the art would be capable of selecting an appropriate type of humidity sensor (among the types listed above, or another type) for a given application.

A single humidity determination can be used, in some cases, to control the humidity within the battery pack. For example, in some embodiments, a humidity sensor can be used to obtain a humidity determination of a first portion of a gas and the humidity determination can be compared to a target humidity. One or more properties of a second portion of the gas used in the system can be altered based, at least in part, upon the comparison. In some cases, multiple humidity determinations can be used to control the humidity within the batter pack. For example, the system may include a first humidity sensor at an upstream position (e.g., within an inlet passageway, within an upstream portion of the battery pack) and a second humidity sensor at a downstream position (e.g., within an outlet passageway, within a downstream portion of the battery pack). Humidity readings from the first and second humidity sensors can be compared, and a property of a gas can be altered in response. As a specific example, the humidity reading from the first, upstream sensor may be larger than the humidity reading from the second, upstream sensor, which may indicate a loss of water vapor via condensation within the battery pack. In such cases, a property of a gas may be altered, for example, until the humidity readings from the first and second sensors are substantially similar.

The humidity determinations described herein can be used to alter a variety of properties of the gases in the system. Properties of the gases in the system can be altered, for example, to inhibit or eliminate condensation within the battery pack and/or any other component of the system.

In some embodiments, a temperature of a gas within the system can be altered (e.g., increased or decreased) based, at least in part, on a humidity determination. The temperature of a gas can be increased, for example, to increase the amount of water vapor that can be retained by the gas, therefore inhibiting condensation from the gas as it is transported through the system. The temperature of a gas can be decreased, for example, if it is determined that the gas within a region of the system is not sufficiently humid to cause condensation at lower temperatures, and lowering the temperature would be useful, for example, to cool a portion of the system (e.g., the battery pack).

In some embodiments, the humidity of a gas within a downstream region of the system can be determined, and the temperature of a gas upstream of the downstream region can be increased. As a specific example, the measured humidity within a region of the battery pack may be relatively high, and, in response, the temperature of at least a portion of the gas within the inlet passageway may be increased to increase the amount of water vapor that can be retained by the inlet gas.

In some cases, the humidity of a gas within a downstream region of the system can be determined, and the temperature of a gas upstream of the downstream region can be decreased. As a specific example, the measured humidity within a region of the battery pack may be relatively low, and, in response, the temperature of at least a portion of the gas within the inlet passageway may be decreased to a temperature sufficiently low to cool the battery pack, but not so low that it causes condensation within the pack.

In some instances, a humidity of a gas within a region of the system can be determined, and the temperature of a gas within substantially the same region can be altered (e.g., increased or decreased). For example, in some embodiments, a humidity of a gas within a region of the system (e.g., within the battery pack, within an inlet and/or outlet passageway, etc.) may be determined to be relatively high. In response, the temperature of a gas in that region may be increased to inhibit condensation and or aid in evaporating condensate that may have already formed proximate to that region. In still other embodiments, the humidity of a gas within an upstream region of the system can be determined, and the temperature of a gas downstream of the upstream region can be altered (e.g., increased or decreased). As a specific example, the measured humidity within an upstream region of an inlet passageway may be relatively high. In response, the temperature of a downstream region of the inlet passageway may be lowered such that water is condensed from the gas (and optionally removed from the system) as it passes through the downstream portion of the inlet passageway, but before it reaches the battery pack.

The temperature of a gas within the system can be altered using any suitable method. The temperature of a gas can be increased, for example, using a heater. In some cases, the temperature can be increased by transferring heat from a relatively hot fluid stream to the gas to be heated (e.g., via a heat exchanger). The temperature of a gas can be lowered, for example, by transferring heat from the gas to be cooled to a relatively cold fluid stream (e.g., from a climate control system in an automobile).

In some embodiments, a flow rate of a gas transported into the battery pack via a passageway fluidically connecting the battery pack to a gas outside the battery pack can be altered based, at least in part, on a humidity determination. In some cases, the humidity of the gas within the inlet passageway may be determined, and the flow rate of the gas transported into the battery pack may be altered in response to the humidity determination in the inlet. For example, if the humidity of the gas within the inlet passageway is sufficiently high to cause condensation within the battery pack, the flow rate of the gas transported into the battery pack may be decreased. If the humidity of the gas within the inlet passageway is relatively low, the flow rate of the gas transported into the battery pack may be increased (e.g., to cool the battery pack and/or to aid in the evaporation of condensate present within the battery pack).

In some cases, the humidity of the gas within the battery pack can be determined, and the flow rate of the gas transported into the battery pack may be altered in response to the humidity determination within the pack. For example, if the humidity of the gas within the battery pack is relatively close to the level of humidity that would cause condensation, the flow rate of the gas transported into the battery pack may be adjusted in response. In some cases, multiple humidity measurements may be combined to determine an appropriate amount of fresh gas to be transported to the battery pack. For example, humidity determinations can be made within the battery pack and within the inlet passageway. If the humidity of the gases within both the pack and the inlet passageway are relatively high, the flow rate of the gas entering the battery pack may be reduced. If the humidity of the gas within the battery pack is relatively high, and the humidity of the gas within the inlet passageway is relatively low, the flow rate of the gas entering the battery pack may be increased.

The flow rate of a gas transported into the battery pack can be controlled using any suitable method. For example, in some cases, one or more inlets to the battery pack may be constructed and arranged to allow one to vary a cross-sectional size of the inlet (e.g., via the actuation of baffles or fins at the inlet). The cross-sectional size of the inlet can be reduced when lower flow rates are desired, and can be increased with higher flow rates are desired. In some cases, the amount of gas transported into the battery pack can be altered by controlling the device used to transport the fresh gas to the battery pack (e.g., a fan or a pump).

In some instances, a ratio of a flow rate of a gas transported into the battery pack to a flow rate of a gas recirculated within the battery pack can be altered based, at least in part, on a humidity determination. For example, in some cases, the humidity of the gas within the inlet passageway can be determined, and if the humidity of the gas in the inlet is sufficiently high to cause condensation, the ratio of the flow rate of the gas transported into the battery pack to the flow rate of the recirculated gas within the battery pack can be reduced. If, on the other hand, the humidity of the gas in the inlet is sufficiently low, the ratio of the flow rate of the gas transported into the battery pack to the flow rate of the recirculated gas within the battery pack can be increased (e.g., to cool the battery pack).

The ratio of fresh gas to battery-pack recirculated components of the gas within the battery pack can be controlled using any suitable method. The flow rate of the fresh gas transported into the battery pack can be controlled using any of the previously mentioned methods (e.g., varying a cross-sectional size of an inlet, controlling the device (e.g., pump) used to transport the fresh gas into the battery pack, etc.). The flow rate of recirculated gas can be controlled using similar methods (e.g., varying a cross-sectional size of a recirculation passageway, controlling the device (e.g., pump) used to transport the recirculated gas within the battery pack). In some embodiments, the ratio of fresh gas to battery-pack recirculated components of the gas within the battery pack can be controlled by adjusting the positions of one or more fins at the gas outlet. For example, FIG. 1B includes fins 121 positioned near the outlet of the battery pack. When the fins are extended into the volume of the battery pack (as shown in FIG. 1B), a portion of the gas that would otherwise exit the pack is directed into the recirculation pathway, as indicated by the curved arrows proximate fins 121 in FIG. 1B. In contrast, FIG. 1A illustrates the operation of the system when fins 121 are either not present, or are retracted (e.g., such that they are flush with the walls of the battery pack). In such embodiments, the flow of the gas exiting the pack is not directed into the recirculation pathway. One of ordinary skill in the art would be capable of identifying other suitable methods of changing the ratio of fresh gas and recirculated gas for a given system.

The battery pack can include, in some cases, at least one temperature sensor. For example, the embodiments illustrated in FIGS. 1A-1B include temperature sensors 123. The temperature sensor can be used to determine the temperature of at least one region within the battery pack. A temperature sensor can be located within any suitable region. In some cases, a temperature sensor can be located within the battery pack. For example, the temperature sensor can be located on the surface of a cell within the pack or on another surface of the battery pack container (e.g., proximate a cell within the pack). A temperature sensor can be located, in some cases, within a recirculation pathway within a battery pack. In some cases, a temperature sensor can be located within the inlet passageway that connects the battery pack to the gas outside the battery pack. A temperature sensor can also be located, in some cases, in an outlet passageway downstream of the battery pack. One of ordinary skill in the art would be capable of positioning a temperature sensor in an appropriate location to achieve a desired temperature determination.

In some cases, a property of a gas can be altered, at least in part, in response to the temperature determination in addition to at least one humidity determination. For example, a temperature of a battery pack can be determined, and a humidity of a gas within an inlet passageway can be determined. Based upon the humidity determination, the dew point of the gas in the inlet passageway can be determined and compared with the temperature within the battery pack. If the dew point of the gas is greater than the temperature within the battery pack, a property of the gas can be altered such that the dew point of the gas is reduced below the temperature within the battery pack to prevent condensation within the battery pack. As another example, a temperature sensor and a humidity sensor can be used to determine the temperature and humidity, respectively, of a gas within an inlet passageway. In response to the temperature and humidity determinations, a property of the inlet gas may be altered (e.g., to increase the water vapor storage capacity of the gas) to prevent condensation within the battery pack.

In some cases, multiple temperature sensors can be used to provide temperature data in multiple locations within the system. Such embodiments can be useful, for example, in determining the location and/or temperature of the coldest part of the system (e.g., the coldest part of the battery pack). Determining the location of the minimum temperature within the battery pack can be useful in locating the area of the battery pack in which condensation is most likely to occur. In addition, determining the value of the minimum temperature within the battery pack can be useful in determining the maximum dew point of air that can contact the coldest point of the battery pack while avoiding condensation. In some embodiments, a property of a gas can be altered, at least in part, in response to the determination of the value of the minimum temperature and/or location of the minimum temperature within the system (e.g., the value and/or location of the minimum temperature within the battery pack) such that the dew point of the gas is lower than the minimum temperature within the battery pack.

The dew point of the air within the battery pack can be controlled, in some embodiments, to ensure that condensation does not occur within the battery. In some cases, the system can be controlled such that the maximum dew point of the air within the battery pack is at least about 1° C., at least about 2° C., at least about 5° C., between about 1° C. and about 10° C., or between about 1° C. and about 5° C. lower than the minimum measured temperature within the battery pack.

In some embodiments, at least one control system can be used to alter one or more properties of a gas in the system (e.g., based upon a humidity determination and/or a temperature determination). For example, FIGS. 1A-1B include control systems 124A and 124B. While FIGS. 1A-1B include two control systems, it should be understood that, in some embodiments, a single control system can be employed. In other cases, more than two control systems can be employed. The control system can be, in some cases, constructed and arranged to receive information from and/or transmit information to at least one humidity sensor within the battery pack. In FIGS. 1A-1B, control systems 124A and 124B are shown exchanging information with humidity sensors 122, as indicated by the dotted lines. In some embodiments, the control system can be constructed and arranged to receive information from and/or transmit information to at least one temperature sensor within the battery pack. In FIGS. 1A-1B, control systems 124A and 124B are shown exchanging information with temperature sensors 123, as indicated by the dotted lines. The transmission of information among components of the battery pack or other components of the system to and/or from the control system can be achieved by any suitable method. For example, in some cases, information can be transmitted along electrical wires. In some embodiments, the information can be transmitted wirelessly.

The control system can be, in some cases, constructed and arranged to receive information from and/or transmit information to a device that is constructed and arranged to alter a property of a gas within the system (e.g., in an inlet passageway, proximate a battery cell within the battery pack, in a recirculation passageway, etc.). For example, the control system can be constructed and arranged to transmit a signal to a heater and/or a cooler used to heat and/or cool, respectively, a gas within any part of the system. In FIGS. 1A-1B, control system 124A is constructed and arranged to communicate with temperature control unit 126, which can be used to heat or cool a gas as it enters the inlet to the battery pack. As another example, the control system can be constructed and arranged to transmit a signal to a pump, fan, or any other suitable device used to control the flow rate of a gas within the system. The control system can also be constructed and arranged, in some cases, to transmit a signal to a device used to control the ratio of fresh gas to battery-pack recirculated components of the gas in the system. For example, in FIG. 1B, control system 124B is constructed and arranged to alter the position of fins 121 such that the ratio of fresh gas to battery-pack recirculated components of the gas is altered.

The control system can be of any suitable type. In some embodiments, the control system can include a microprocessor constructed and arranged to perform one or more calculations the result of which may be used to change a property of the system. In some cases, the control system may include memory. The memory can be used, for example, a lookup table that can be used, for example, to convert an absolute humidity reading to a relative humidity value. In some cases, the control system will be constructed and arranged to receive information from and/or transmit information to at least one humidity sensor in the system (e.g., on or proximate a cell within the battery pack, in an inlet passageway, in a recirculation passageway, in an outlet passageway, etc.).

Various embodiments according to the invention may be implemented on one or more computer systems. For example, the control systems described herein can include a computer system, in some embodiments. These computer systems, may be, for example, general-purpose computers such as those based on Intel processors, Motorola PowerPC, Motorola DragonBall, IBM HPC, Sun UltraSPARC, Hewlett-Packard PA-RISC processors, any of a variety of processors available from Advanced Micro Devices (AMD) or any other type of processor. It should be appreciated that one or more of any type of computer system may be used to implement various embodiments of the invention. The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

The systems and methods described herein can be used in any suitable system in which a battery pack is employed. In some embodiments, the systems and methods can be used to control the flow of gas within a battery pack system used in an automobile (e.g., within the drive train of an electric or hybrid automobile). In embodiments where the battery pack is used in an automobile, the battery pack can be positioned in any suitable location (e.g., under the floor board, in the trunk, under the front hood, etc.). Fresh gas supplied to the battery pack can originate from any suitable location. For example, fresh gas may originate from an air intake, the flow of which can be driven by the natural motion of the automobile and/or by a pump or other suitable device. In some cases, the fresh air may exchange heat within and/or be transported through a climate control system within the automobile. In some cases, the climate control system may be specifically constructed and arranged to exchange heat primarily with air used to control the climate within the battery pack. In other cases, the climate control system may be constructed and arranged to exchange heat with separate air streams used to control the climate within the battery pack and the passenger compartment of the automobile.

The battery pack can be formed in any suitable shape (e.g., a rectangular prism, cylinder, sphere, etc.). In addition, the systems and methods described herein can be used with battery packs of any suitable size.

U.S. Provisional Patent Application No. 61/325,033, filed Apr. 16, 2010, and entitled “Battery Humidity Control” is incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system for inhibiting condensation within a battery pack, comprising:
a humidity sensor constructed and arranged to determine the humidity of a first gas portion to which at least one region within the battery pack is or will be exposed; and
a control system constructed and arranged to alter, responsive at least in part to the humidity determination, a dew point of a second gas portion such that condensation is inhibited.

2. A system for controlling humidity within a battery pack, comprising:
a humidity sensor constructed and arranged to determine the humidity of a first gas portion to which at least one region within the battery pack is or will be exposed; and
a control system constructed and arranged to alter, responsive at least in part to the humidity determination, at least one of a temperature of a second gas portion, a flow rate of a second gas portion, and/or a ratio of fresh to battery-pack recirculated components of a second gas portion.

3. A system for controlling humidity within a battery pack, comprising:
a battery pack comprising at least one electrochemically rechargeable battery cell;
a passageway fluidically connecting the battery pack to a gas outside the battery pack;
a passageway within the battery pack constructed and arranged to provide a flow path for recirculated gas within the battery pack;
a humidity sensor constructed and arranged to determine the humidity of at least one region within the battery pack and/or within the passageway; and
a control system constructed and arranged to establish a ratio of a flow rate of the gas from outside the battery back to a flow rate of the recirculated gas based at least in part upon the humidity determination.

4. A system for controlling humidity within a battery pack, comprising:
a battery pack comprising at least one electrochemically rechargeable battery cell;
a passageway fluidically connecting the battery pack to a gas outside the battery pack;
a humidity sensor constructed and arranged to determine the humidity of at least one region within the battery pack and/or the passageway; and
a control system constructed and arranged to alter a temperature of the gas from outside the battery pack based at least in part upon the humidity determination.

5. A system for altering the humidity within a battery pack, comprising:
a battery pack comprising at least one electrochemically rechargeable battery cell;
a passageway fluidically connecting the battery pack to a gas outside the battery pack;
a humidity sensor constructed and arranged to determine the humidity of at least one region within the battery pack; and
a control system constructed and arranged to alter a flow rate of the gas from outside the battery pack into the battery pack based at least in part upon the humidity determination.

6. A system as in claim 1, wherein the first and second gas portions comprise different portions of a larger volume of gas.

7. A system as in claim 1, wherein the first gas and the second gas comprise substantially the same portions of gas.

8. A system as in claim 1, wherein the control system is constructed and arranged to alter, responsive at least in part to the humidity determination, a dew point of a second gas such that condensation is inhibited.

9. A system as in claim 1, further comprising a temperature sensor constructed and arranged to determine a temperature of a region within the battery pack.

10. A system as in claim 1, wherein the control system is constructed and arranged to alter the dew point of the second gas based at least in part upon the determination of the temperature of the region within the battery pack.

11. A system as in claim 1, further comprising a plurality of temperature sensors constructed and arranged to determine a minimum temperature of the battery pack.

12. A system as in claim 1, wherein the control system is constructed and arranged to alter the dew point of the second gas based at least in part upon the determination of the minimum temperature of the battery pack.

13. A system as in claim 1, wherein the battery pack comprises a single electrochemically rechargeable battery cell.

14. A system as in claim 1, wherein the battery pack comprises a plurality of electrochemically rechargeable battery cells.

15. A system as in claim 1, wherein the gas comprises a climate control gas for controlling the climate within the battery pack.

16. A system as in claim 1, wherein the humidity sensor is located within the battery pack.

17. A system as in claim 1, wherein the humidity sensor is located within the passageway within the battery pack constructed and arranged to provide a flow path for recirculated gas within the battery pack

18. A system as in claim 1, wherein the humidity sensor is located within the passageway fluidically connecting the battery pack to a gas outside the battery pack.

19. A system as in claim 1, wherein the battery pack is constructed and arranged to power, at least in part, a vehicle.

20. A system as in claim 1, wherein the battery pack is constructed and arranged to power, at least in part, the drive train of a vehicle.

21. A method for inhibiting condensation within a battery pack, comprising:
determining the humidity of a first gas portion to which at least one region within a battery pack is exposed, and
altering a property of a second gas portion, based at least in part upon the humidity determination, such that the dew point of the second gas portion is lower than a minimum temperature within the at least one region within the battery pack.

22. A method for controlling humidity within a battery pack, comprising:
determining the humidity of at least one region within a battery pack comprising at least one electrochemically rechargeable battery cell and/or within a passageway fluidically connecting the battery pack to a gas outside the battery pack, and
altering at least one of a temperature of a gas transported into the battery pack, a flow rate of the gas transported into the battery pack, and/or a ratio of a flow rate of the gas transported into the battery pack to a flow rate of a gas recirculated within the battery pack based at least in part upon the humidity determination.

23. A method as in claim 21, wherein the first and second gas portions comprise different portions of a larger volume of gas.

24. A method as in claim 21, wherein the first gas and the second gas comprise substantially the same portions of gas.

25. A method as in claim 21, comprising altering a temperature of a gas transported into the battery pack.

26. A method as in claim 21, comprising altering a flow rate of the gas transported into the battery pack based at least in part upon the humidity determination.

27. A method as in claim 21, comprising altering a flow rate of the gas transported into the battery pack based at least in part upon the humidity determination.

28. A method as in claim 21, comprising altering a ratio of a flow rate of the gas transported into the battery pack to a flow rate of a gas recirculated within the battery pack based at least in part upon the humidity determination.

29. A method as in claim 21, further comprising determining the value of the minimum temperature within the battery pack.

30. A method as in claim 21, further comprising determining the location of the minimum temperature within the battery pack.

31. A method as in claim 21, wherein the battery pack comprises a single electrochemically rechargeable battery cell.

32. A method as in claim 21, wherein the battery pack comprises a plurality of electrochemically rechargeable battery cells.

33. A method as in claim 21, wherein the battery pack is used to power, at least in part, a vehicle.

34. A method as in claim 21, wherein the battery pack is used to power, at least in part, the drive train of a vehicle.

35. A method as in claim 21, wherein a gas is used to control a temperature within the battery pack.
